(19) United States
(12) Patent Application Publication
(10) Pub. No.: US 2013/0272516 A1
(43) Pub. Date: Oct. 17, 2013

(54) SYSTEM AND METHOD FOR DYNAMICALLY ROUTING A SPECIAL NUMBER CALL TO A FUNCTION-FOCUSED ANSWERING UNIT

(71) Applicant: WEST CORPORATION, Omaha, NE (US)

(72) Inventors: John Lawrence Snapp, Westminster, CO (US); George Heinrichs, Longmont, CO (US); Daniel Zacek, Boulder, CO (US)

(73) Assignee: West Corporation, Omaha, NE (US)

(21) Appl. No.: 13/848,972

(22) Filed: Mar. 22, 2013

Related U.S. Application Data
(60) Provisional application No. 61/625,146, filed on Apr. 17, 2012.

(51) Int. Cl. H04M 11/04

(52) U.S. Cl. CPC H04M 11/04
USPC 379/211.02

(57) ABSTRACT

A system for dynamically coupling a special number call from a calling unit with at least one function-focused answering unit includes: (a) at least one communication network configured and situated for communicative coupling with the calling unit; (b) at least one switching facility coupled with at least one network of the plurality of networks; (c) a special number call receiving facility coupled with the at least one switching facility; and (d) the at least one switching facility being coupled with the at least one function-focused answering unit. After receiving the special number call, the special number call receiving facility directs dynamically coupling the special number call to one or more included function-focused answering unit of the at least one function-focused answering unit via the at least one switching facility. Determination which function-focused answering unit is an included function-focused answering unit is made at the special number call receiving facility.

### CROSS-REFERENCE TO RELATED APPLICATIONS

This application is a continuation from Provisional U.S. Patent Application Ser. No. 61/625,146, entitled “SYSTEM AND METHOD FOR DYNAMICALLY ROUTING A SPECIAL NUMBER CALL TO A FUNCTION-FOCUSED ANSWERING UNIT,” filed on Apr. 17, 2012, which is incorporated by reference herein in its entirety.

### FIELD OF THE INVENTION

The present invention is directed to telecommunication systems, and especially to routing or coupling a special number call to at least one function-focused call recipient during the special number call.

### BACKGROUND OF THE INVENTION

Special Number calls may be placed using a variety of mobile communication devices. By way of example and not by way of limitation, special number calls maybe placed using land line telephones using a Plain Old Telephone System (POTS), Internet Protocol (IP) phones, mobile telephones, Personal Digital Assistant (PDA) devices, “Smart” phones, automatic crash notification (ACN) units, mobile radio devices and other communication devices.

A special number call may involve a specialized need that may be best addressed by a function-focused specialized responder. By way of example and not by way of limitation, a special number call reporting a wildfire may be best fielded by a firefighters' command center, an accident related with a traffic jam pursuant to a football game may best be addressed by a university police command center and during a presidential visit all special service calls within a projected movement zone for the President may best be handled by the US Secret Service (USSS). Some responders may maintain function-focused answering units that may be communicatingly coupled to handle a special number call requiring function-focused assistance.

Changing locations, conditions, services sought by the call or other circumstances may require that the routing of the special number call may need to be reevaluated so that coupling with new or additional function-focused entities may need to be effected during the special number call.

Examples of such special number calls are 9-1-1 calls for seeking emergency services and other abbreviated number calls for non-emergency special services, such as “N-1-1” systems. Examples of such N-1-1 systems include “3-1-1” (urgent but not emergency calls) and “5-1-1” (traffic inquiry calls). Special number calls may also include, by way of further example and not by way of limitation, abbreviated numbers for calling commercial services, such as “*820” (calling a radio station) or “GOTIX” (calling for tickets).

For purposes of illustration, by way of example and not by way of limitation, the present invention will be described in the context of an emergency service network in the United States, commonly referred to as a 9-1-1 network. The teachings of the present invention are equally applicable, useful and novel in other special number calling systems, such as maintenance service networks, college campus security networks, abbreviated number networks for calling commercial services and other networks.

A user engaged in a 9-1-1 call seeking emergency services relies on an emergency service call taker or receiver, such as an operator at a Public Safety Answering Point (PSAP; sometimes referred to as a Public Safety Answering Position), to marshal appropriate and sufficient assets to handle an extant emergency situation. Such marshalling is often best carried out by conferring with asset holders, such as first responders (e.g., fire, police and emergency personnel) and the like. Direct communications among an emergency service caller and responding agencies rather than relaying information among participants can be an effective and efficient mode of operation for handling a situation.

Direct involvement by specialized responders may be especially advantageous when a function-focused entity is involved in the call so that their special expertise can be brought to bear early on in the situation giving rise to the call. The PSAP may bridge the call to the function-focused entity, may reroute the call to the function-focused entity, may establish a conference call arrangement whereby the PSAP and the function-focused entity both remain on the line or may otherwise include the function-focused entity in the call.

It may be advantageous to carry out the coupling by, for example, rerouting or bridging at a network switching facility. Network switching facilities may include, by way of example and not by way of limitation, a Mobile Switching Center (MSC) coupled with a radio access network or an unlicensed mobile access network, or an End Office (EO) coupled with a Public Switched Telephone Network (PSTN).

Dynamic routing or bridging or other coupling to a function-focused answering unit is particularly advantageous in that dynamic re-coupling may be carried out in a manner that does not break the connection with the caller and permits re-coupling of the caller with the function-focused answering unit without the caller having to redial the call.

There is a need for a system and method for dynamically routing a special number call to a function-focused answering unit. For purposes of this description, the term “dynamic routing” means routing that may be carried out in a manner that does not break a connection between a caller and a first call recipient and permits re-routing of the caller with at least one second call recipient without the caller having to redial the call.

### SUMMARY OF THE INVENTION

A system for dynamically coupling a special number call from a calling unit with at least one function-focused answering unit includes: (a) at least one communication network configured and situated for communicative coupling with the calling unit; (b) at least one network switching facility coupled with at least one of the at least one communication network; (c) a special number call receiving facility coupled with the at least one network switching facility; and (d) the at least one network switching facility being coupled with the at least one function-focused answering unit. After receiving the special number call, the special number call receiving facility directs dynamically coupling the special number call to one or more included function-focused answering unit of the at least one function-focused answering unit via the at least one network switching facility. Determination which function-focused answering unit is an included function-focused answering unit is made at the special number call receiving facility.

A method for dynamically coupling a special number call from a calling unit with at least one function-focused answering unit includes: (a) receiving the special number call at a special number call receiving facility via a network switching facility; (b) if location information relating to locus of the calling unit is received with the special number call, proceeding to step (d); (c) if no location information relating to locus of the calling unit is received with the special number call, obtaining the location information from a location determining facility coupled with at least one of the network switching facility and the special number call receiving facility; (d) evaluating service required by caller placing the special number call; (e) evaluating location of one or more included function-focused answering unit of the at least one function-focused answering unit; (f) directing coupling of the special number call via the network switching facility with one or more included function-focused answering unit of the at least one function-focused answering unit; (g) if treatment necessitated by the special number call is complete, proceed to step (k); (h) if treatment necessitated by the special number call is not complete, in no particular order: (1) determining whether a change in the treatment has occurred; and (2) determining whether a change in the locus has occurred; (i) if a change has occurred in the treatment or in the locus, repeating steps (d) through (h); (j) if no change has occurred in the treatment or in the locus, repeating steps (g) through (h); and(k) terminating the method.

It is, therefore, a feature of the present invention to provide a system and method for dynamically routing a special number call to a function-focused answering unit.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic illustration of a system for effecting the present invention.

FIG. 2 a flow diagram illustrating the method of the present invention.

FIG. 3 is a schematic diagram illustrating call routing for a system configured according to the teaching of the present invention deployed in a representative multi-network arrangement.

FIG. 4 is a schematic diagram of a situation in which the present invention may be advantageously employed.

### DETAILED DESCRIPTION

For purposes of illustration, by way of example and not by way of limitation, the present invention will be discussed in the context of an emergency service network in the United States, commonly referred to as an E9-1-1 network. The teachings of the present invention are equally applicable, useful and novel in other special number calling systems, such as maintenance service networks, college campus security networks and other networks.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

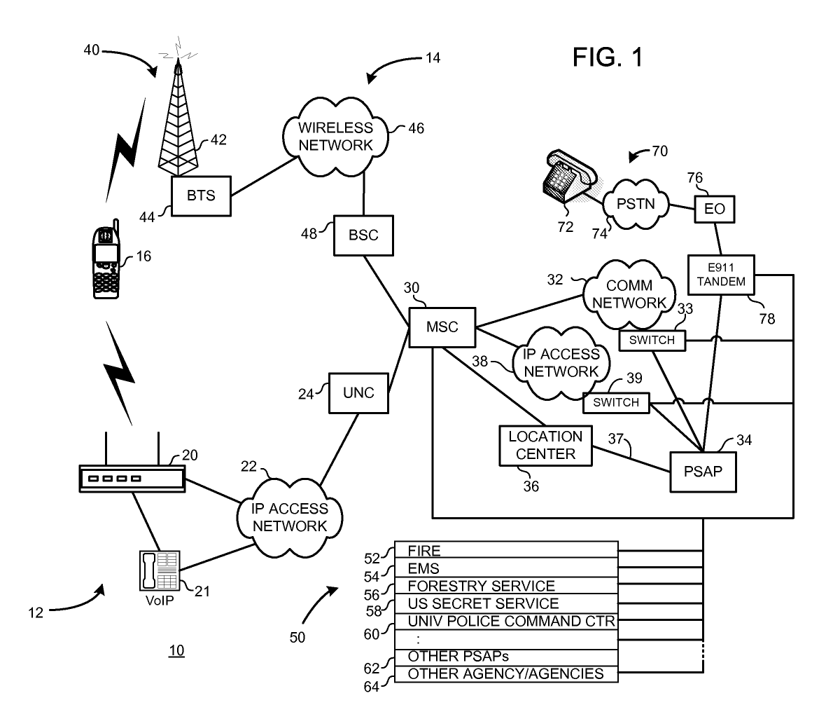

FIG. 1 is a schematic illustration of a system for effecting the present invention. In FIG. 1, a telecommunication system 10 includes an Unlicensed Mobile Access (UMA) Network (UMAN) 12, a Radio Access Network (RAN) 14 and a Plain Old Telephone System (POTS) network 70.

UMAN 12 may be embodied in, by way of example and not by way of limitation, a Wi-Fi network, a Bluetooth network or another type of UMAN. RAN 14 may be embodied in, by way of example and not by way of limitation, a cellular network or a Personal Communication System (PCS) network employing any of several communication protocols including, by way of further example and not by way of limitation, GSM or another protocol using Time Division Multiple Access (TDMA), Code Division Multiple Access (CDMA) or another coding scheme. UMAN 12 and RAN 14 are configured for wireless communication with a wireless calling unit or instrument 16. Wireless calling unit 16 may be embodied in a wireless calling device including, by way of example and not by way of limitation, mobile telephone, Personal Digital Assistant (PDA) devices, “Smart” phones, automatic crash notification (ACN) units, mobile radio devices and similar communication devices.

UMAN 12 includes an access unit 20 coupled with an Internet Protocol (IP) access network 22. Access unit 20 facilitates communication between wireless communicating unit 16 and IP network 22. IP network 22 is coupled with a UMA Network Controller (UNC) 24. UNC 24 is coupled with a Mobile Switching Center (MSC) 30. MSC 30 is coupled with a communication network 32. Communication network 32 is coupled with a PSAP 34 via a switch 33. MSC 30 is also coupled with a location center 36.

As may be understood by those skilled in the art of communication system design, a Voice over Internet Protocol (VoIP) phone could be coupled in any of networks 12, 14, 70 to advantage and could benefit from the present invention. A representative VoIP phone 21 is illustrated in FIG. 1 as coupled within UMAN 12. Specifically, VoIP phone 21 is indicated as being coupled with one or both of access unit 20 and IP network 22.

PSAP 34 may be coupled with MSC 30 via an IP network 38 via a switch 39 to permit communication between PSAP 34 and MSC 30 without involving communication network 32. PSAP 34 may be directly coupled with location center 36 via a direct connection 37 to permit communication between PSAP 34 and location center 36 without traversing an intervening network.

RAN 14 includes an access unit 40 that includes a radio antenna embodied in a radio tower 42 and a Base Transceiver Station (BTS) 44 coupled with radio tower 42. BTS 44 is coupled with a private network 46. Private network 46 may be embodied in, by way of example and not by way of limitation, a cellular network or a PCS network employing any of several communication protocols including, by way of further example and not by way of limitation, GSM or another protocol using Time Division Multiple Access (TDMA), Code Division Multiple Access (CDMA) or another coding scheme. Access unit 40 facilitates communication between wireless communicating unit 16 and private network 46. Private network 46 is coupled with a Base Station Controller (BSC) 48. BSC 48 is coupled with MSC 30.

POTS 70 includes a land line telephone unit 72 coupled with a PSTN 74. PSTN 74 is coupled with an End Office (EO) 76 and EO 76 is coupled with a 911 Tandem switch 78. 911 tandem switch 78 is coupled with PSAP 34.

At least one of MSC 30, switch 33, switch 39 and 911 tandem switch 78 is coupled for selectively communicating with various function-focused entities 50 such as, by way of example and not by way of limitation, a fire agency 52, an emergency medical service (EMS) 54, the forestry service 56, the US Secret Service 58, a University Police Command Center 60, other PSAPs 62 and other function-focused entities 64. Any of PSAP 34, MSC 30, 911 tandem 78, switch 33, switch 39 and EO 76 may be communicatively coupled with function-focused entities 50 via IP network 38, via communication network 32, via location center 36 or via another network. Such alternate connections and networks are understood by those skilled in the art of telecommunication system design, but are not shown in FIG. 1 in order to avoid cluttering FIG. 1.

Equipment and support for providing dynamic routing or coupling of a call with a function-focused entity 50 may be advantageously situated at one or more of MSC 30, switch 33, switch 39 and 911 tandem switch 78. Situating equipment and support in one or more of MSC 30, switch 33, switch 39 and 911 tandem switch 78 may be a cost effective configuration to avoid the cost of providing equipment and support for providing dynamic coupling of calls with function-focused entities 50 in each of several PSAPs that may be coupled with and supported by one or more of MSC 30, switch 33, switch 39 and 911 tandem switch 78. In any configuration, it is likely that PSAP 34 will be in the best operational position to decide whether to couple (e.g., by bridging or routing) an emergency service call to a function-focused entity 50. This is so because PSAP 34 likely has the first-available information relating to the nature of the situation occasioning the placing of the emergency service call. The nature of the situation occasioning the placing of the emergency service call likely will drive any decision whether to involve a function-focused entity 50 and, if so, which function-focused entity or entities to involve.

Calling unit 16 may wirelessly access UMAN 12 to place an emergency 9-1-1 call via access unit 20 to establish communication with PSAP 34 via IP network 22, UNC 24, MSC 30 and one or both of communication network 32 and IP network 38.

VoIP phone 21 may access UMAN 12 to place an emergency 9-1-1 call via access unit 20 and IP network 22 (or may directly access IP network 22) to establish communication with PSAP 34 via UNC 24ₛ and MSC 30.

Calling unit 16 may instead wirelessly access RAN 14 to place an emergency 9-1-1 call via BTS 44 to establish communication with PSAP 34 via BSC 48, MSC 30 and one or both of communication network 32 and IP network 38.

Telephone unit 72 (telephone unit 72 may also be referred to herein as a calling unit 72) may access PSAP 34 via PSTN 74, EO 76 and 911 tandem 78.

When communication is established between a calling unit 16, 21, 72 and PSAP 34, PSAP 34 may inquire of calling unit 16, 21, 72 or inquire of a user of calling unit 16, 21, 72 regarding the circumstance or circumstances that are the occasion for the call. PSAP 34, or an operator or evaluator manning PSAP 34 can evaluate or triage the situation described by calling unit 16, 21, 72 (e.g., in the case of an ACN unit) or a user of calling unit 16, 21, 72 and may be able to identify the nature of the circumstances.

PSAP 34 or an operator or evaluator manning PSAP 34 can also inquire of the caller as to the locus of the caller, or the location may be ascertained using other means such as, by way of example and not by way of limitation, Global Positioning System (GPS) satellite information accompanying the call signal and cell-and-tower information or other information obtained involving location center 36.

Once the caller's locus or a special nature of an occasion for the call is determined, PSAP 34 or an operator or evaluator manning PSAP 34 may determine that certain of function-focused entities 50 should be involved in the call to aid in coordinating assistance rendered in response to the call. Communications may be effected by PSAP 34 by cooperation between PSAP 34 and one or more of MSC 30, switch 33, switch 39 and 911 tandem switch 78, or via another arrangement so that appropriate function-focused entities 50 may be included function-focused entities participating in the emergency service call originally placed to PSAP 34. Preferably PSAP 34 may direct which function-focused entities 50 remain involved in the emergency service call. PSAP 34 or an operator or evaluator manning PSAP 34 may change participants in the call during the call as necessary such as when assistance requirements, caller locus or other circumstances change. A voice link between calling unit 16, 72 and the first-connected party to the call, such as PSAP 34, may remain a priority connection throughout the duration of the emergency service call.

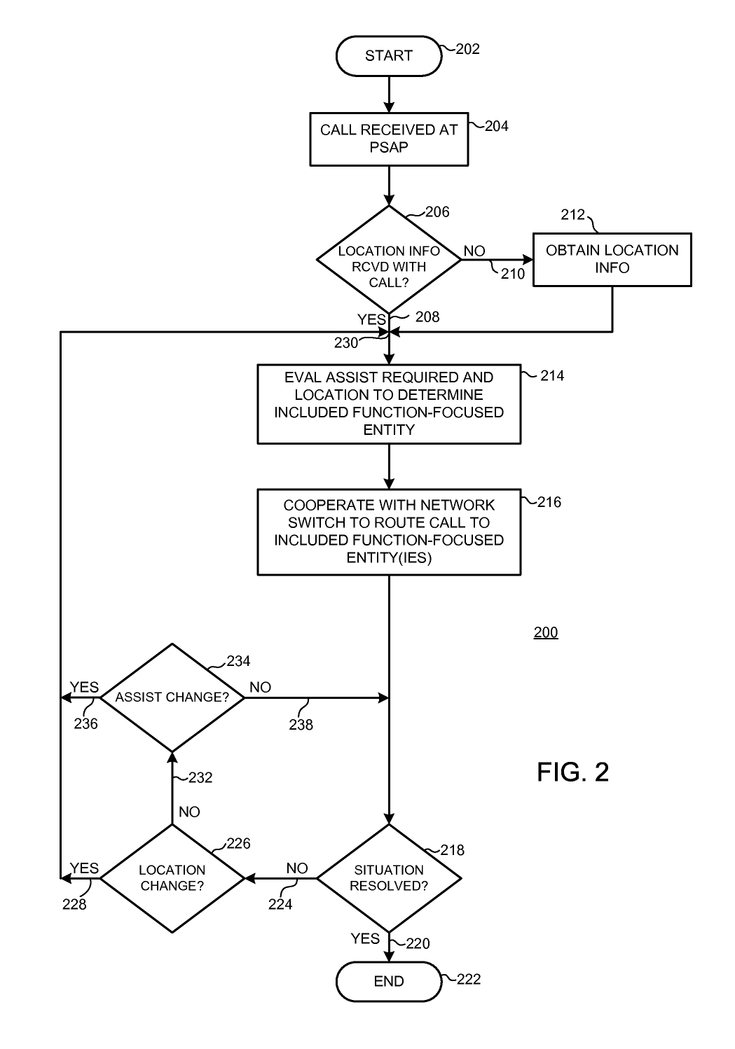

FIG. 2 is a flow diagram illustrating the method of the present invention. In FIG. 2, a method 200 for substantially simultaneously routing a special number call from a calling unit to at least one function-focused answering unit associated with a function-focused entity begins at a START locus 202.

Method 200 continues with receiving the special number call at a special number call receiving facility via a network switching facility, as indicated by a block 204.

Method 200 continues with posing a query whether location information relating to locus of the calling unit is received with the special number call, as indicated by a query block 206. If location information relating to locus of the calling unit is received with the special number call, method 200 proceeds from query block 206 via a YES response line 208 to evaluate service required by the caller placing the special number call, including determining which function-focused answering units may be available to assist and, based upon agency capabilities and location, and which function-focused answering units should be included in the special number call, as indicated by a block 214.

If no location information relating to locus of the calling unit is received with the special number call, method 200 proceeds from query block 206 via a NO response line 210 to obtain location information relating to locus of the calling unit from a location determining facility coupled with at least one of the network switching facility and the special number call receiving facility, as indicated by a block 212. Method 200 thereafter proceeds from block 212 to evaluate service required by the caller placing the special number call, including determining which function-focused answering units may be available to assist and, based upon function-focused answering units capabilities and location, and which function-focused answering units should be included in the special number call, as indicated by a block 214.

Method 200 continues with cooperating with a network switch or a 911 tandem switch to effect routing the special number call to one or more included function-focused answering units of the at least one function-focused answering unit, as indicated by a block 216.

Method 200 continues with posing a query whether the situation occasioning the special number call has been resolved, as indicated by a query block 218. If the situation occasioning the special number call has been resolved, method 200 proceeds from query block 218 via a YES response line 220 and method 200 terminates, as indicated by an END locus 222.

If the situation occasioning the special number call has not been resolved, method 200 proceeds from query block 218 via a NO response line 224 and, in no particular order, poses queries indicated by query blocks 226, 234. Only for purposes of illustration of method 200, query block 226 first poses a query whether the locus of the calling unit has changed. If the locus of the calling unit has changed, method 200 proceeds from query block 226 via a YES response line 228 to a juncture 230, and method 200 thereafter repeats steps indicated by blocks 214, 216, 218, 226.

If the locus of the calling unit has not changed, method 200 proceeds from query block 226 via a NO response line 232 and method 200 poses a query whether assistance required by the caller placing the special number call has changed, as indicated by a query block 234. If assistance required by the caller placing the special number call has changed, method 200 proceeds from query block 234 via a YES response line 236 to juncture 230, and method 200 thereafter repeats steps indicated by blocks 214, 216, 218, 226, 234.

If assistance required by the caller placing the special number call has not changed, method 200 proceeds from query block 234 via a NO response line 238 and method 200 thereafter repeats the step indicated by block 218.

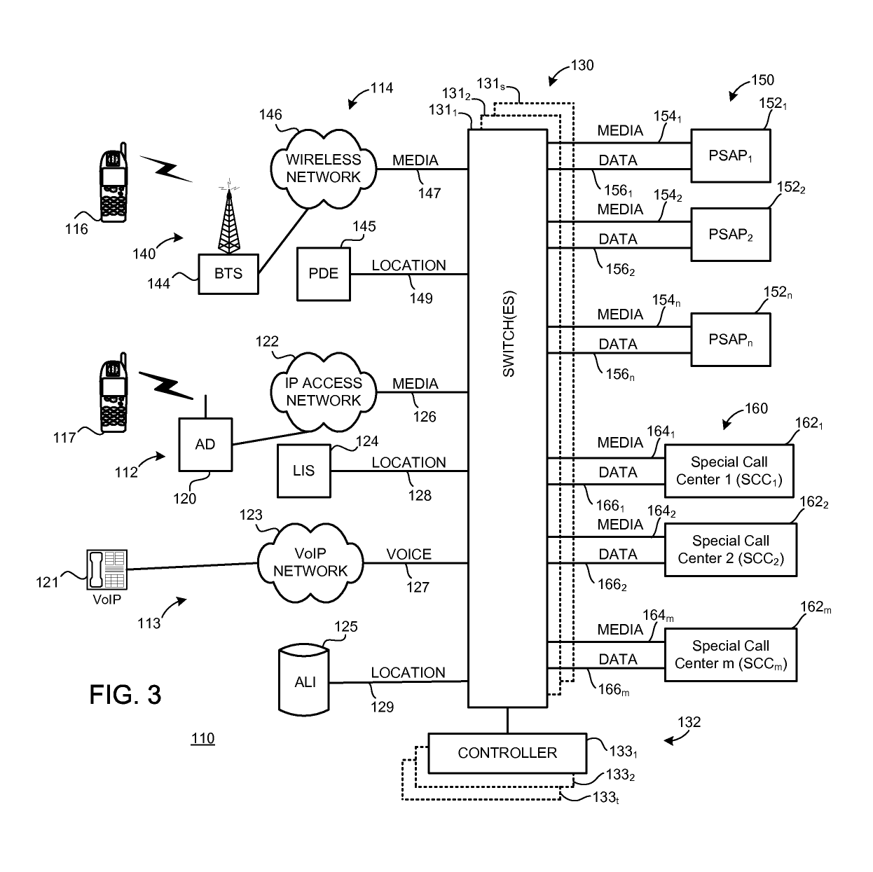

FIG. 3 is a schematic diagram illustrating call routing for a system configured according to the teaching of the present invention deployed in a representative multi-network arrangement. In FIG. 3, a communication system 110 includes an Unlicensed Mobile Access (UMA) Network (UMAN) 112, a Radio Access Network (RAN) 14 and a Voice over Internet Protocol Network (VoIP) 113. A Plain Old Telephone System (POTS) network (see FIG. 1; 70) may also be included in system 110, as will be understood by one skilled in the art of communication systems design. A POTS network is not included I FIG. 3 in order to reduce cluttering of FIG. 3.

UMAN 112 may be embodied in, by way of example and not by way of limitation, a Wi-Fi network, a Bluetooth network or another type of UMAN. RAN 114 may be embodied in, by way of example and not by way of limitation, a cellular network or a Personal Communication System (PCS) network employing any of several communication protocols including, by way of further example and not by way of limitation, GSM or another protocol using Time Division Multiple Access (TDMA), Code Division Multiple Access (CDMA) or another coding scheme. UMAN 112 is configured for wireless communication with a wireless calling unit or instrument 116. RAN 114 is configured for wireless communication with a wireless calling unit or instrument 117. VoIP 113 is configured for Internet communication with a VoIP calling unit or instrument 121. Wireless calling units 116, 117, 121 may be embodied in a wireless calling device including, by way of example and not by way of limitation, mobile telephone, Personal Digital Assistant (PDA) devices, “Smart” phones, automatic crash notification (ACN) units, mobile radio devices and similar communication devices. VoIP calling unit 117 may be embodied in a wireless or wired calling device configured for communicative connection with the Internet.

UMAN 112 includes an access unit 120 coupled with an Internet Protocol (IP) access network 122. Access unit 120 facilitates communication between wireless communicating unit 117 and IP access network 122. IP access network 122 is coupled with a network switching facility 130. Network switching facility 130 may include one or more communication switches 131₁, 131₂, 131ₛ. The indicator “s” is employed to signify that there can be any number of communication switches in network switching facility 130. The inclusion of three communication switches 131₁, 131₂, 131ₛ in FIG. 3 is illustrative only and does not constitute any limitation regarding the number of communication switches that may be included in the communication system of the present invention. Throughout this description, use of a reference numeral using a generic subscript herein may be taken to mean that any respective member of the plurality of elements having the same reference numeral may be regarded as included in the description. Thus, by way of example and not by way of limitation, referring to communication switch 131ₛ in describing FIG. 3 may be taken to mean that any communication switch—131₁, 131₂ or 131ₛ (FIG. 3)—may be regarded as capable of employment as described.

IP access network 122 is coupled with a communication switch 131ₛ via a media line 126. A Location Information System (LIS) 124 may be associated with IP access network 122 and may provide location information via a communication switch 131ₛ via a location information line 128. Network switching facility 130 (embodied in one or more communication switch 131ₛ) is coupled with various call receiving entities such as, by way of example and not by way of limitation, PSAPs 150 and function-focused answering units 160.

PSAPs 150 may include a PSAP 152₁ coupled with network switching facility 130 via a media line 154₁ and a data line 156₁; a PSAP 152₂ coupled with network switching facility 130 via a media line 154₂ and a data line 156₂; and a PSAP 152ₙ coupled with network switching facility 130 via a media line 154ₙ and a data line 156ₙ. The indicator “n” is employed to signify that there can be any number of PSAPs 150 coupled with network switching facility 130. The inclusion of three PSAPs 152₁, 152₂, 152ₙ in FIG. 3 is illustrative only and does not constitute any limitation regarding the number of PSAPs 150 that may be included in the communication system of the present invention.

Function-focused answering units 160 may include a Special Call Center (SCC) 162₁ coupled with network switching facility 130 via a media line 164₁ and a data line 166₁; a SCC 162₂ coupled with network switching facility 130 via a media line 164₂ and a data line 166₂; and a SCC 152ₘ coupled with network switching facility 130 via a media line 164ₘ and a data line 166ₘ. The indicator “m” is employed to signify that there can be any number of SCCs 160 coupled with network switching facility 130. The inclusion of three SCCs 162₁, 162₂, 162ₘ in FIG. 3 is illustrative only and does not constitute any limitation regarding the number of SCCs 160 that may be included in the communication system of the present invention.

RAN 114 includes an access unit 140 that includes a radio antenna embodied in a radio tower 142 and a Base Transceiver Station (BTS) 144 coupled with radio tower 142. BTS 144 is coupled with a private network 146. Private network 146 may be embodied in, by way of example and not by way of limitation, a cellular network or a PCS network employing any of several communication protocols including, by way of further example and not by way of limitation, GSM or another protocol using Time Division Multiple Access (TDMA), Code Division Multiple Access (CDMA) or another coding scheme. Access unit 140 facilitates communication between wireless communicating unit 116 and private network 146. Private network 146 is coupled with a communication switch 131ₛ via a media line 147. A Position Determining Entity (PDE) 145 may be associated with private network 146 and may provide location information via a communication switch 131ₛ via a location information line 149.

VoIP 113 includes a VoIP network 123. VoIP network 123 may be a stand-alone network, or VoIP network 123 may be embodied in IP access network 122. VoIP network 123 facilitates communication between VoIP communicating unit 121 and various call receiving entities such as PSAPs 150 and function-focused answering units 160 via a communication switch 131ₛ via a voice line 127. An Automatic Location Information (ALI) unit 125 may be associated with VoIP network 123 and may provide location information via a communication switch 131ₛ via a location information line 129. Location information providing units PDE 145, LIS 124 and ALI 125 may not necessarily be associated with networks as indicated in FIG. 3 but may instead be associated with other networks (including networks not illustrated in FIG. 3).

A network switching controller facility 132 may include one or more controller units 133₁, 133₂, 133ₛ coupled with and controlling operation of network switching facility 130. The indicator “t” is employed to signify that there can be any number of communication switches in network switching controller facility 132. The inclusion of three controller units 133₁, 133₂, 133ₛ in FIG. 3 is illustrative only and does not constitute any limitation regarding the number of controller units that may be included in the communication system of the present invention.

When communication is established between a calling unit 116, 117, 121 and a PSAP 152ₙ, PSAP 152ₙ may inquire of calling unit 116, 117, 121 or inquire of a user of calling unit 116, 117, 121 regarding the circumstance or circumstances that are the occasion for the call. PSAP 152ₙ, or an operator or evaluator manning PSAP 152ₙ can evaluate or triage the situation described by calling unit 116, 117, 121 (e.g., in the case of an ACN unit) or a user of calling unit 116, 117, 121 and may be able to identify the nature of the circumstances.

PSAP 152ₙ or an operator or evaluator manning PSAP 152ₙ can also inquire of the caller as to the locus of the caller, or the location may be ascertained using other means such as, by way of example and not by way of limitation, Global Positioning System (GPS) satellite information accompanying the call signal and cell-and-tower information or other information obtained involving one or more location information providing units PDE 145, LIS 124, ALI 125.

Once the caller's locus or a special nature of an occasion for the call is determined, PSAP 152ₙ or an operator or evaluator manning PSAP 152ₙ may determine that certain of function-focused entities 160ₘ should be involved in the call to aid in coordinating assistance rendered in response to the call. Communications may be directed via a communication switch 131ₛ of network switching facility 130 to one or more function-focused entity 160ₘ by PSAP 152ₙ so that appropriate function-focused entities 160ₘ may be included function-focused entities participating in the emergency service call originally placed to PSAP 152ₙ. PSAP 152ₙ or an operator or evaluator manning PSAP 152ₙ may change participants in the call during the call as necessary such as when assistance requirements, caller locus or other circumstances change. A voice link between calling unit 116, 117, 121 and the first-connected party to the call, such as PSAP 152ₙ, may remain a priority connection throughout the duration of the emergency service call.

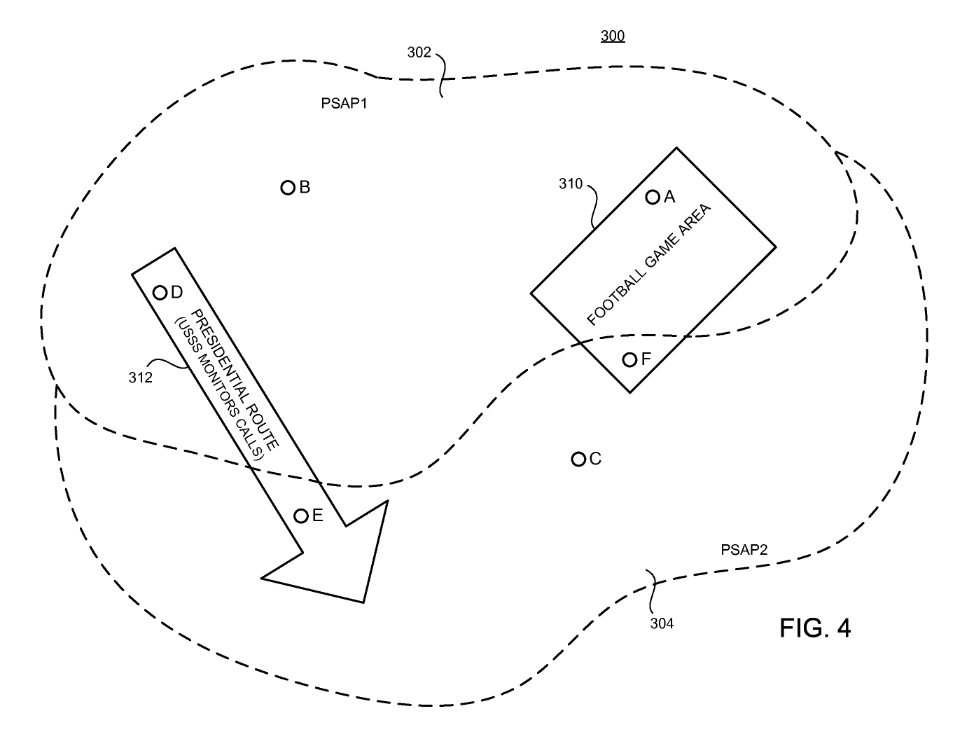

FIG. 4 is a schematic diagram of a situation in which the present invention may be advantageously employed. In FIG. 4, a geographic area 300 is divided into a first area 302 served by a first PSAP (PSAP1) and a second area 304 served by a second PSAP (PSAP2). Geographic limits of respective coverage areas 302, 304 relating to PSAP1, PSAP2 are indicated in FIG. 4 using a dashed line format.

A football game area 310, which may include a football stadium and surrounding parking areas, is situated with a first portion located within the purview or area of responsibility of PSAP1 and a second portion located within the purview of PSAP2.

A planned route for a presidential motorcade is indicated as passing through geographic area 300 by an arrow 312. The route 312 is planned to pass through areas within the purview of PSAP1 and the purview of PSAP2.

If, by way of example and not by way of limitation, a caller places an emergency service request call from a locus “A” in FIG. 4, a receiving PSAP 152ₙ (e.g., PSAP1) may ascertain the caller's location as being locus “A” and may direct the call via a communication switch 131ₛ to a function-focused entity 160ₘ assigned to provide service at locus “A” (such as, for example, university police or security services at football game area 310). Alternatively, the emergency service request all may be routed via a communication switch 131ₛ directly to a function-focused entity 160ₘ assigned to provide service at locus “A” (such as, for example, security services at football game area 310).

If, by way of further example and not by way of limitation, a caller places an emergency service request call from a locus “B” in FIG. 4, the call may be routed via a communication switch 131ₛ to PSAP1.

If, by way of further example and not by way of limitation, a caller places an emergency service request call from a locus “C” in FIG. 4, the call may be routed via a communication switch 131ₛ to PSAP2.

If, by way of further example and not by way of limitation, a caller places an emergency service request call from a locus “D” in FIG. 4, a receiving PSAP 152ₙ (e.g., PSAP1) may ascertain the caller's location as being locus “D” and may direct the call via a communication switch 131ₛ to a function-focused entity 160ₘ assigned to provide service at locus “D” (such as, for example, a US Secret Service call center assigned to provide security along presidential route 312). Alternatively, the emergency service request all may be routed via a communication switch 131ₛ directly to a function-focused entity 160ₘ assigned to provide service at locus “D” (such as, for example, a US Secret Service call center assigned to provide security along presidential route 312).

If, by way of further example and not by way of limitation, a caller places an emergency service request call from a locus “E” in FIG. 4, a receiving PSAP 152ₙ (e.g., PSAP2) may ascertain the caller's location as being locus “E” and may direct the call via a communication switch 131ₛ to a function-focused entity 160ₘ assigned to provide service at locus “E” (such as, for example, a US Secret Service call center assigned to provide security along presidential route 312). Alternatively, the emergency service request all may be routed via a communication switch 131ₛ directly to a function-focused entity 160ₘ assigned to provide service at locus “E” (such as, for example, a US Secret Service call center assigned to provide security along presidential route 312).

If, by way of further example and not by way of limitation, a caller places an emergency service request call from a locus “F” in FIG. 4, a receiving PSAP 152ₙ (e.g., PSAP2) may ascertain the caller's location as being locus “F” and may direct the call via a communication switch 131ₛ to a function-focused entity 160ₘ assigned to provide service at locus “F” (such as, for example, security services at football game area 310). Alternatively, the emergency service request all may be routed via a communication switch 131ₛ directly to a function-focused entity 160ₘ assigned to provide service at locus “F” (such as, for example, security services at football game area 310).

It is to be understood that, while the detailed drawings and specific examples given describe embodiments of the invention, they are for the purpose of illustration only, that the system and method of the invention are not limited to the precise details and conditions disclosed and that various changes may be made therein without departing from the spirit of the invention which is defined by the following claims:

1. A system for dynamically coupling a special number call from a calling unit with at least one function-focused answering unit; the system comprising:
(a) at least one communication network configured and situated for communicative coupling with said calling unit;
(b) at least one network switching facility coupled with at least one of said at least one communication network;
(c) a special number call receiving facility coupled with said at least one network switching facility; and
(d) said at least one network switching facility being coupled with said at least one function-focused answering unit;
after receiving said special number call, said special number call receiving facility directing said dynamically coupling said special number call to one or more included function-focused answering unit of said at least one function-focused answering unit via said at least one network switching facility; determination which function-focused answering unit of said at least one function-focused answering unit is an included function-focused answering unit being made at said special number call receiving facility.

2. The system for dynamically coupling a special number call from a calling unit with at least one function-focused answering unit as recited in claim 1 wherein the system further comprises a location determining facility coupled with at least one of said at least one network switching facility and said special number call receiving facility; said special number call receiving facility cooperating with said location determining facility to effect said directing said dynamic coupling.

3. The system for dynamically coupling a special number call from a calling unit with at least one function-focused answering unit as recited in claim 1 wherein said network switching facility is one of a mobile switching center coupled with at least one of an unlicensed mobile access network and a radio access network, or an end office coupled with a public switched telephone network.

4. The system for dynamically coupling a special number call from a calling unit with at least one function-focused answering unit as recited in claim 1 wherein communication between said special number call receiving facility and a respective included function-focused answering unit may be established as at least one of voice communication and data communication.

5. The system for dynamically coupling a special number call from a calling unit with at least one function-focused answering unit as recited in claim 1 wherein which function-focused answering unit of said at least one function-focused answering unit is directed as an included function-focused answering unit may be changed by said special number call receiving facility during said special number call.

6. The system for dynamically coupling a special number call from a calling unit with at least one function-focused answering unit as recited in claim 2 wherein said network switching facility is one of a mobile switching center coupled with at least one of said at least one communication network.

7. The system for dynamically coupling a special number call from a calling unit with at least one function-focused answering unit as recited in claim 6 wherein communication between said special number call receiving facility and a respective included function-focused answering unit may be established as at least one of voice communication and data communication.

8. The system for dynamically coupling a special number call from a calling unit with at least one function-focused answering unit as recited in claim 7 wherein which function-focused answering unit of said at least one function-focused answering unit is directed as an included function-focused answering unit may be changed by said special number call receiving facility during said special number call.

9. A method for dynamically coupling a special number call from a calling unit with at least one function-focused answering unit; the method comprising:
(a) receiving said special number call at a special number call receiving facility via a network switching facility;
(b) if location information relating to locus of said calling unit is received with said special number call, proceeding to step (d);
(c) if no location information relating to locus of said calling unit is received with said special number call, obtaining said location information from a location determining facility coupled with at least one of said network switching facility and said special number call receiving facility;
(d) evaluating service required by caller placing said special number call;
(e) evaluating location of one or more included function-focused answering unit of said at least one function-focused answering unit;
(f) directing coupling of said special number call via said network switching facility with one or more included function-focused answering unit of said at least one function-focused answering unit;
(g) if treatment necessitated by said special number call is complete, proceed to step (k);
(h) if treatment necessitated by said special number call is not complete, in no particular order:
(1) determining whether a change in said treatment has occurred; and
(2) determining whether a change in said locus has occurred;
(i) if a change has occurred in said treatment or in said locus, repeating steps (d) through (h);
(j) if no change has occurred in said treatment or in said locus, repeating steps (g) through (h); and
(k) terminating the method.

10. The method for dynamically coupling a special number call from a calling unit with at least one function-focused answering unit as recited in claim 9 wherein said network switching facility is one of a mobile switching center coupled with at least one of an unlicensed mobile access network and a radio access network, or an end office coupled with a public switched telephone network.

11. The method for dynamically coupling a special number call from a calling unit with at least one function-focused answering unit as recited in claim 9 wherein communication between said special number call receiving facility and a respective included function-focused answering unit may be established as at least one of voice communication and data communication.

12. The method for dynamically coupling a special number call from a calling unit with at least one function-focused answering unit as recited in claim 9 wherein which function-focused answering unit of said at least one function-focused answering unit is an included function-focused answering unit may be changed by direction of said special number call receiving facility during said special number call.

13. The method for dynamically coupling a special number call from a calling unit with at least one function-focused answering unit as recited in claim 10 wherein communication between said special number call receiving facility and a respective included function-focused answering unit may be established as at least one of voice communication and data communication.

14. The method for dynamically coupling a special number call from a calling unit with at least one function-focused answering unit as recited in claim 13 wherein which function-focused answering unit of said at least one function-focused answering unit is an included function-focused answering unit may be changed by direction of said special number call receiving facility during said special number call.

15. A system for dynamically coupling an emergency service call from a calling unit with at least one function-focused answering unit; the system comprising:
(a) at least one communication network configured and situated for communicative coupling with said calling unit;
(b) at least one network switching facility coupled with at least one of said at least one communication network; and
(c) a public service answering position coupled with said at least one network switching facility; at least one of said public service answering position and said at least one network switching facility being configured for effecting communicative coupling of said special number call with said at least one function-focused answering unit;
after receiving said special number call, said public service answering position directing said dynamically coupling said special number call to one or more included function-focused answering unit of said at least one function-focused answering unit via said at least one network switching facility; determination which function-focused answering unit of said at least one function-focused answering unit is an included function-focused answering unit being made at said public service answering position.

16. The system for dynamically coupling an emergency service call from a calling unit with at least one function-focused answering unit as recited in claim 15 wherein the system further comprises a location determining facility coupled with at least one of said at least one network switching facility and said public service answering position; said public service answering position cooperating with said location determining facility to effect said directing said dynamic coupling.

17. The system for dynamically coupling an emergency service call from a calling unit with at least one function-focused answering unit as recited in claim 15 wherein which function-focused answering units of said at least one function-focused answering unit is an included function-focused answering unit may be changed by said public service answering position during said emergency service call.

18. The system for dynamically coupling an emergency service call from a calling unit with at least one function-focused answering unit as recited in claim 15 wherein communication between said public service answering position and a respective included function-focused answering unit may be established as at least one of voice communication and data communication.

19. The system for dynamically coupling an emergency service call from a calling unit with at least one function-focused answering unit as recited in claim 16 wherein which function-focused answering units of said at least one function-focused answering unit is an included function-focused answering unit may be changed by said public service answering position during said emergency service call.

20. The system for dynamically coupling an emergency service call from a calling unit with at least one function-focused answering unit as recited in claim 19 wherein communication between said public service answering position and a respective included function-focused answering unit may be established as at least one of voice communication and data communication.
